(19) United States
(12) Patent Application Publication
(10) Pub. No.: US 2022/0071448 A1
(43) Pub. Date: Mar. 10, 2022

(54) HERB GRINDER

(71) Applicant: SC Shredder IPP, LLC, Campbell, CA (US)

(72) Inventors: Matt Hansen, Watsonville, CA (US); Mark Edwards, Campbell, CA (US)

(21) Appl. No.: 17/082,510

(22) Filed: Oct. 28, 2020

Related U.S. Application Data
(63) Continuation-in-part of application No. 29/749,563, filed on Sep. 7, 2020.

(51) Int. Cl. A47J 42/30; A47J 42/24

(52) U.S. Cl. CPC A47J 42/30; A47J 42/24

(57) ABSTRACT

This disclosure addresses an herb grinder that includes an upper grinder rotatably inserted into a lower grinder. The lower grinder is non-rotatably affixed to a sifter, which is in turn non-rotatably affixed to a bottom element. The upper grinder includes a plurality of downward projecting grinding teeth, and the lower grinder includes a plurality of upward projecting grinding teeth so that the two sets of teeth mesh with each other to enable the grinding function. A plurality of pass-through holes in the lower grinder allows ground material to pass from a material receiving space formed between the upper grinder and the lower grinder into a coarse material collecting area in the sifter. The sifter includes a planar sifting plate with a plurality of holes that allow powder to pass therethrough.

### CROSS REFERENCE TO RELATED APPLICATIONS

This application claims priority of U.S. Design application Ser. No. 29/749,563, filed Aug. 25, 2020, the disclosure of which is incorporated herein in its entirety by reference.

### FIELD OF THE DISCLOSURE

The present disclosure relates generally to food processing devices, and more particularly is an herb grinder.

### SUMMARY

In various embodiments of the present disclosure, an herb grinder includes an upper grinder rotatably inserted into a lower grinder. The lower grinder is non-rotatably affixed to a sifter, and the sifter is non-rotatably affixed to a bottom element. The upper grinder includes a plurality of grinding teeth projecting downward toward the lower grinder, and the lower grinder includes a plurality of grinding teeth projecting upward toward the upper grinder. The teeth of the upper grinder and the teeth of the lower grinder intermesh with each other.

The lower grinder also includes a plurality of pass-through holes, the pass-through holes allowing ground material to pass from a material receiving space formed between the upper grinder and the lower grinder into a coarse material collecting area in the sifter.

The sifter includes a planar sifting plate with a plurality of holes. The holes in the sifting plate allow powder product to pass through into a collecting area in the bottom element.

### BRIEF DESCRIPTION OF THE DRAWINGS

The accompanying drawings, wherein like reference numerals refer to identical or functionally similar elements throughout the separate views, together with the detailed description below, illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a perspective view of an herb grinder.

FIG. 2 is an exploded view showing the four main elements of the herb grinder.

FIG. 3 shows a perspective view of a top grinder element.

FIG. 4 is a top perspective view of a lower grinder.

FIG. 5 is a top view of the lower grinder.

FIG. 6 is a bottom perspective view of the lower grinder.

FIG. 7 shows a perspective view of a sifter.

FIG. 8 is an inverted perspective view of a bottom element.

FIG. 9 is a top plan view of the bottom element.

### DETAILED DESCRIPTION

The present disclosure is directed to devices used to grind herbs. In particular, the devices are well suited to grinding cannabis.

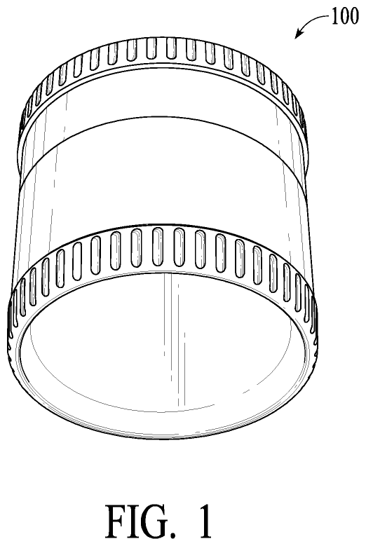

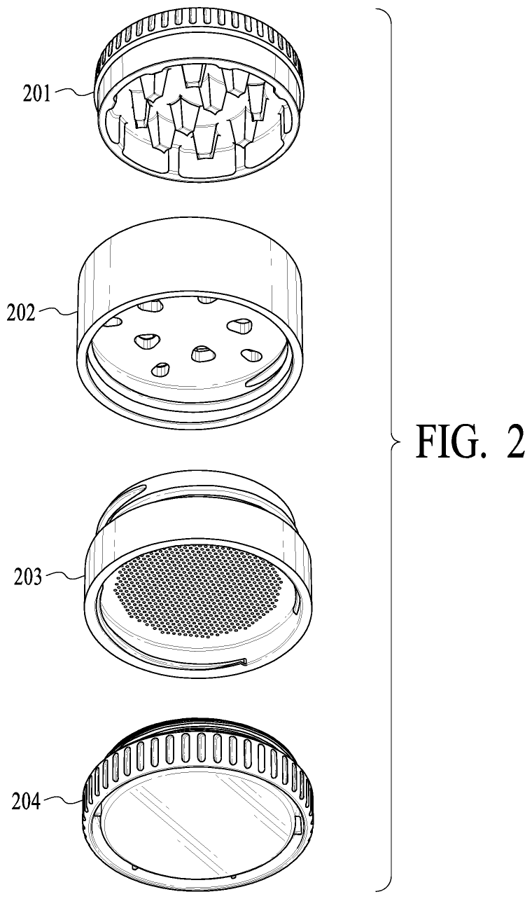

Referring first to FIGS. 1 and 2, an herb grinder 100 includes four basic elements: an upper grinder element 201, a lower grinder element 202, a sifter 203, and a bottom element 204.

The upper grinder 201 is rotatably inserted into the lower grinder 202. The lower grinder 202 is threadedly affixed to the sifter 203, which is in turn threadedly affixed to the bottom 204. While any means of fastening is acceptable for joining the lower grinder 202 to the sifter 203 and in turn to the bottom 204, the upper grinder 201 must be rotatable relative to the lower grinder 202 in order for the grinder 100 to function properly.

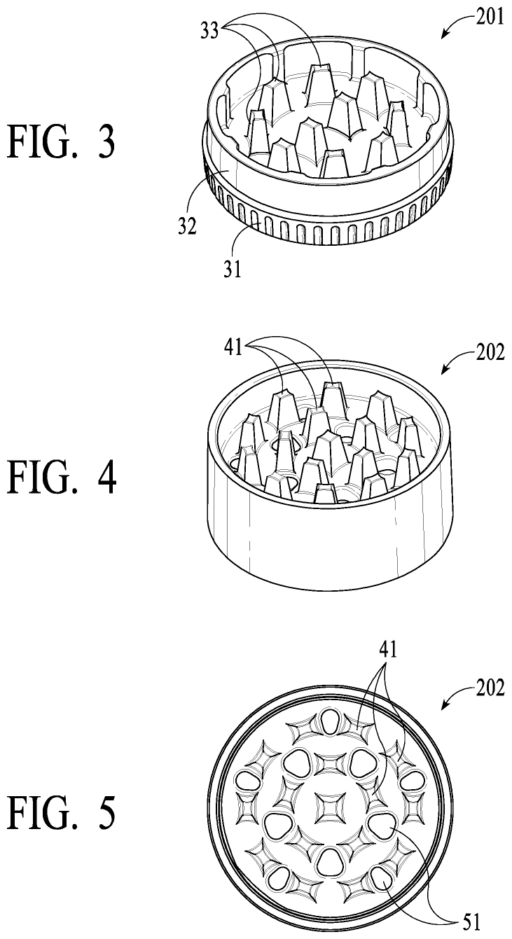

FIG. 3 shows the upper grinder 201. The upper grinder 201 includes a grip portion 31 that enables a user to securely grasp the upper grinder 201. A flange 32 is received in the upper portion of the lower grinder 202, securing the upper grinder 201 in the lower grinder 202. The upper grinder 201 further includes multiple upper grinding teeth 33 projecting downward from a top surface of the upper grinder 201.

FIG. 4 shows the lower grinder 202. A key feature of the lower grinder 202 is a plurality of lower grinding teeth 41. The lower grinding teeth 41 project upward from a bottom surface of the lower grinder 202. The lower grinding teeth 41 can be nearly any shape desired by a user, but must be positioned so as to intermesh with the upper grinding teeth 33.

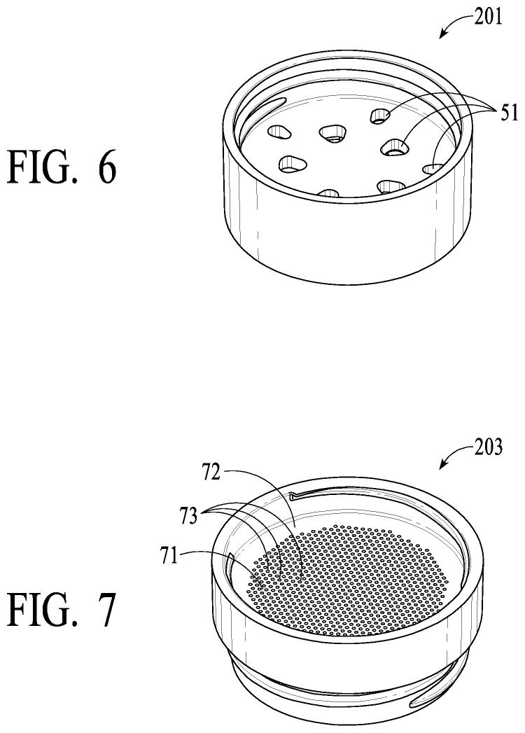

FIG. 5 is a top view of the lower grinder 202 that more clearly shows the pass-through holes 51 that allow product to pass through the lower grinder 202 and on to the sifter 203. The pass-through holes 51 are also clearly visible in FIG. 6.

FIG. 7 shows a perspective view of a sifter element 203. The sifter 203 includes a coarse material collecting area 72 that collects the coarser herb (relative to the powder generated by the sifter 203) that is ground by the upper grinder 201 and the lower grinder 202. A sifting plate 71 includes a plurality of circular holes 73 which allow powdered herb to pass through the coarse material collecting area 72 to a powder collecting area 91 in the bottom 204 of the grinder 100. The sifting plate 71 is formed as a planar element. This enables the sifting plate 71, in conjunction with the grinders 201, 202, to grind and separate coarse and powder material. Prior art devices all use wire mesh construction, yielding a sifting plate that is uneven along the surface that contacts the herb, and also forms non-circular holes used to process the product. The non-circular holes and non-planar surface of current art sifting plates generates a poor efficiency for the sifting plate, and therefore the grinder in general. The design of the current sifting plate 71 typically enables at least a threefold improvement in yield in the resultant powder product as compared to known devices. The improvement is realized both in volume of powder and quality of yielded product.

The sifting plate 71 is in many embodiments water etched or laser etched to form the holes 73 therein. The sifting plate 71 may be formed from hemp, cold pressed under pressure, then water etched to form the holes 71. This yields a biodegradable product. The sifting plate 71 may also be formed from plastic or metal.

It should be noted that in the case of grinding cannabis, the powdered herb product is the much desired trichomes of the plant. The yield of this product with the design disclosed herein is generally three times that of current art herb grinders.

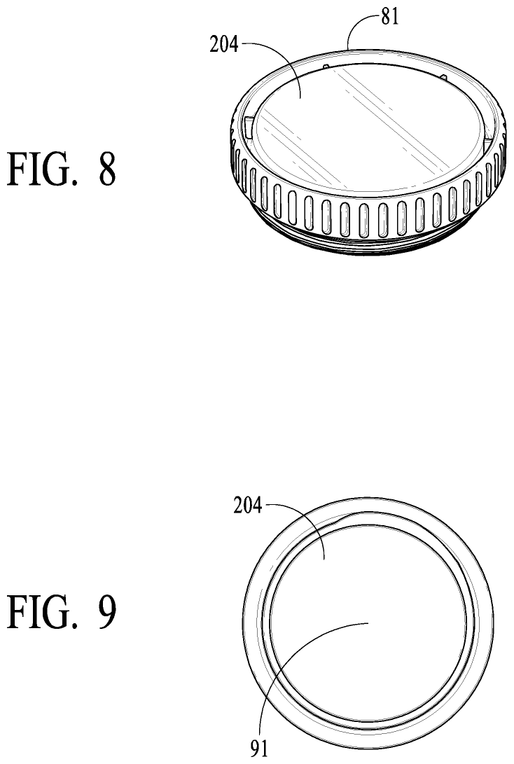

The bottom element 204 can be seen in detail in FIGS. 8 and 9. The bottom element 204 may be equipped with a grip element 81 to facilitate rotation during operation. The bottom element 204 also includes the powder collecting area 91.

Overall function of the herb grinder 100 may perhaps be best understood with reference first to FIG. 2. The upper grinder 201 is rotatably inserted into the lower grinder 202. The lower grinder 202 is threadedly affixed to the sifter 203, which is in turn threadedly affixed to the bottom element 204. This configuration means that the upper grinder 201 rotates relative to the rest of the assembly.

Herb is loaded into a material receiving space defined between the upper grinder 201 and the lower grinder 202. The upper grinder 201 is rotated relative to the lower grinder 202 by the user gripping the grips 31 and 81 and rotating the elements. The initial grinding of the herb causes the coarse product to fall through the holes 51 in the lower grinder 202 where it is collected in the coarse material collecting area 72.

The coarse material is then further processed by the action of the sifter 203. The coarse material moves across the sifting plate 71 to separate the trichome rich powder material from the coarse material. The powder material then falls through the holes 73 in the sifting plate 71 where it is collected in the powder collecting area 91. The sifting action can be accentuated by the user. If the user moves the grinder 100 in a back and forth motion, the sifter 203 acts as a separating pan, like those used for panning for gold.

The technology disclosed herein addresses improved herb grinder configurations. The improvements disclosed are independent of the actual materials used.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

In the foregoing description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

1. An herb grinder comprising:
an upper grinder having a non-insertable portion and an insertable portion, the insertable portion being rotatably inserted into a lower grinder, the lower grinder being configured to accommodate the insertable portion of the upper grinder, the lower grinder being non-rotatably affixed to a sifter, the sifter being non-rotatably affixed to a bottom element; wherein
the upper grinder comprises a plurality of grinding teeth projecting downward toward the lower grinder,
the lower grinder comprises a plurality of grinding teeth projecting upward toward the upper grinder, the teeth of the upper grinder meshing with the grinding teeth of the lower grinder,
the lower grinder further comprises a plurality of pass-through holes, the pass-through holes allowing ground material to pass from a space formed between the upper grinder and the lower grinder into a coarse material collecting area in the sifter,
the sifter comprising a planar sifting plate with a plurality of holes therein, the holes in the sifting plate allowing powder to pass therethrough into a collecting area in the bottom element.

2. The herb grinder of claim 1, wherein:
the holes in the sifting plate are circular.

3. The herb grinder of claim 1, wherein:
the pass-through holes in the lower grinder are larger in diameter than the holes in the sifting plate.

4. The herb grinder of claim 1, wherein:
a material receiving space is formed between the upper grinder and the lower grinder.

5. The herb grinder of claim 1, wherein:
both the upper grinder and the bottom element include grip elements to facilitate rotation of the upper grinder relative to the bottom element which causes rotation of the upper grinder relative to the lower grinder.
